(19) United States
(12) Patent Application Publication
(10) Pub. No.: US 2015/0128734 A1
(43) Pub. Date: May 14, 2015

(54) INVOLUTE NON-RING CONTINUOUS TEETH SPHERICAL GEAR TRANSMISSION MECHANISM

(71) Applicant: HANLIN HONG, WORCESTER, MA (US)

(72) Inventor: HANLIN HONG, WORCESTER, MA (US)

(21) Appl. No.: 14/327,706

(22) Filed: Jul. 10, 2014

(30) Foreign Application Priority Data
Nov. 11, 2013 (CN) 2013104904439

(51) Int. Cl. F16H 19/08

(52) U.S. Cl. CPC F16H 19/08
USPC 74/98

(57) ABSTRACT

An involute, non-ring, continuous teeth, spherical gear transmission mechanism includes a female and a male spherical gear to form a three degree-of-freedoms deputy campaign. And its design regularity is the same as that of common one degree-of-freedom gear, which is involute tooth profile for continuous engagement, therefore such spherical gears have the same transmission features as common one degree-of-freedom gear, like fixed transmission ratio and efficiency. This invention (utility) of involute non-ring continuous teeth spherical gear transmission mechanism solve problems that distributed-teeth spherical gear cannot provide accurate fixed ratio transmission and that spherical involute gear can only provide 2 degree of freedoms. It provides a better condition of spherical gear mechanism for wide use in practical engineering applications.

### FIELD OF THE INVENTION

This invention relates to a spherical gear mechanism having an involute, non-ring, continuous teeth, spherical gear transmission mechanism.

### BACKGROUND

A spherical gear is an innovative transmission mechanism. Being different to a common gear which has 1 degree of freedom, a spherical gear can transmit two or three degrees of freedom. This matches motion of most animal joints in nature, therefore it attracts widespread interest.

Currently, there are two spherical gear mechanism available. One is a distributed-teeth spherical gear mechanism that utilizes a male element comprising conical finger-shaped teeth and a female, mating element comprising concaves for engagement. FIG. 1(a) illustrates such a spherical gear mechanism. However, due to its contour being straight, it cannot provide accurate fixed ratio transmission, and so this type of spherical gear mechanism is not widely used in practical engineering applications.

FIG. 1(b) illustrates the second type of spherical gear mechanism, which is a spherical involute gear mechanism. Such a gear mechanism is based on an involute tooth profile and formed by circumferential array. However this mechanism can only provide two degrees of freedom, and so it limits further applications.

### BRIEF DESCRIPTION OF THE DRAWINGS

FIG. 1(a) is distributed-teeth spherical gear mechanism.

FIG. 1(b) is spherical involute gear mechanism.

FIG. 2(a) is schematic of female spherical gear of this invention.

FIG. 2(b) is schematic of male spherical gear of this invention.

FIG. 3 is multi-views of female spherical gear.

FIG. 4 is multi-views of male spherical gear.

FIG. 5 is schematic of engagement where the center concave tooth of female gear and the center convex tooth of male gear pair each other. The pair of spherical gears shown here has fixed transmission ratio of 1:1, and female gear is the driving while male gear is the driven.

FIG. 6 is schematic of engagement of this pair of spherical gear when the female gear (driving gear) rotates 45 degrees around itself z-axis in FIG. 5.

FIG. 7 is schematic of engagement of this pair of spherical gear when the female gear (driving gear) rotates 90 degrees around itself x-axis in FIG. 5.

FIG. 8 is schematic of engagement of this pair of spherical gear when the female gear (driving gear) rotates 45 degrees around itself z-axis in FIG. 7.

FIG. 9 is schematic, of engagement of this pair of spherical gear when the female gear (driving gear) rotates 90 degrees around itself y-axis in FIG. 5.

FIG. 10 is schematic of engagement of this pair of spherical gear when the female gear (driving gear) rotates 45 degrees around itself z-axis in FIG. 9.

FIG. 11 is schematic of engagement of this pair of spherical gear when the female gear (driving gear) rotates 90 degrees around itself x-axis in FIG. 9.

FIG. 12 is a schematic of a two DOF female Gear

FIG. 13 is a schematic of the two DOF female gear in FIG. 12 in cross section.

FIG. 14 is a schematic of the two DOF female gear.

FIG. 15 is a schematic of the two DOF female gear in FIG. 14 in cross section.

FIG. 16 is a schematic of a three DOF female gear.

FIG. 17 is a schematic of the three DOF female gear in FIG. 16 in cross section.

FIG. 18 is a schematic of the three DOF female gear in FIG. 16 with a chuck.

FIG. 19 is a schematic of a three DOF male gear with a chuck.

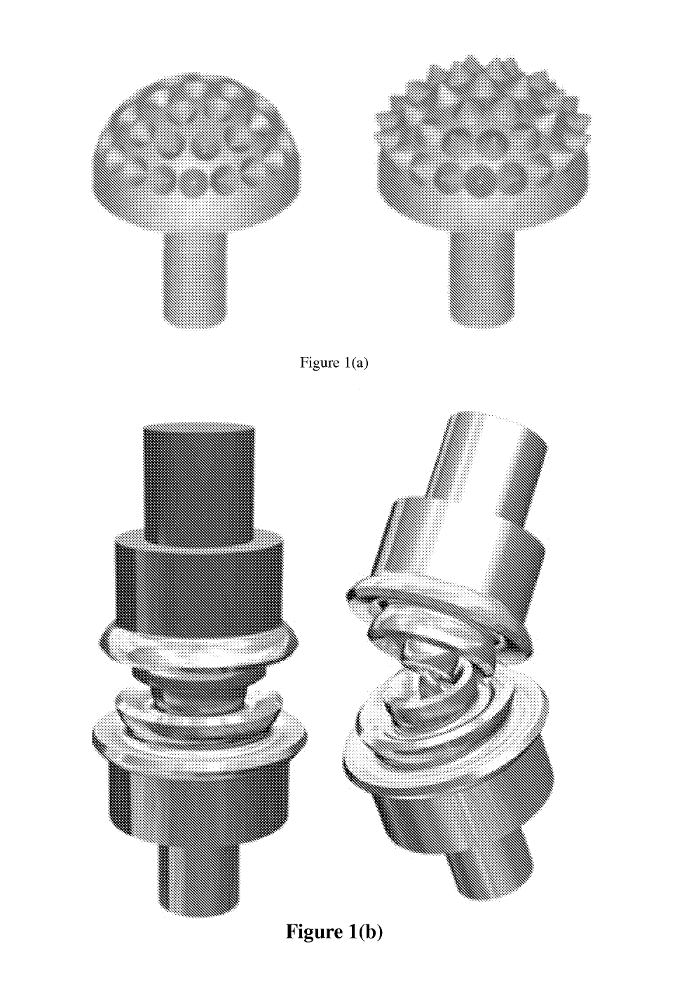

### CROSS REFERENCE TO RELATED APPLICATIONS

This application claims the benefit under 35 U.S.C. 119 of Chinese Patent Application Serial No. 2013/206446500 entitled “INVOLUTE NON-RING CONTINUOUS TEETH SPHERICAL GEAR TRANSMISSION MECHANISM”, filed Oct. 19, 2013, the entire contents of which are incorporated herein by reference.

### DETAILED DESCRIPTION

Figure Labels: 10. female spherical gear (driving gear); 11. cylindrical pin as chucking mechanism of female spherical gear; 12. involute teeth profile of female spherical gear; 13. the center concave tooth of female spherical gear (driving gear); 20. male spherical gear (driven gear); 21. cylindrical pin as chucking mechanism of male spherical gear; 22. involute teeth profile of male spherical gear; 23. the center convex tooth of male spherical gear (driven gear).

In order to overcome the limitations of the currently available spherical gear designs, I have designed an involute, non-ring, continuous teeth, spherical gear transmission mechanism which can engage continuously. It helps to solve problems that distributed-teeth spherical gear cannot provide accurate fixed ratio transmission and that spherical involute gear can only provide two degrees of freedom.

The involute non-ring continuous teeth spherical gear transmission mechanism mentioned above which helps to solve those problems includes a female and a corresponding male spherical gear, which form a three degrees of freedom deputy campaign. The involute teeth profile of both female and male spherical gears are calculated from gear module and tooth numbers, and the calculated results include pitch sphere diameter, root sphere diameter, outside sphere diameter and other design parameters, whose calculation is the same as common one degree-of-freedom gears.

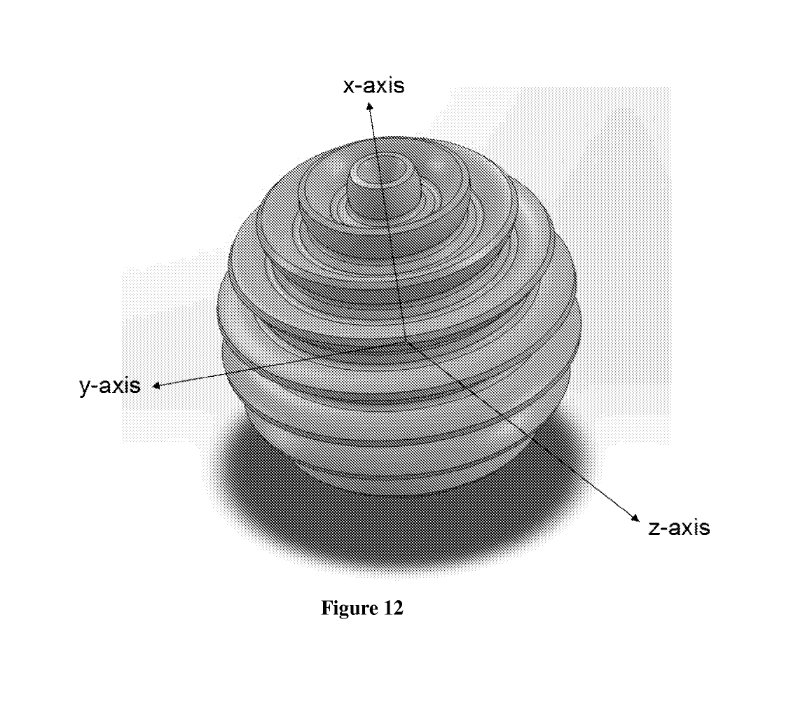

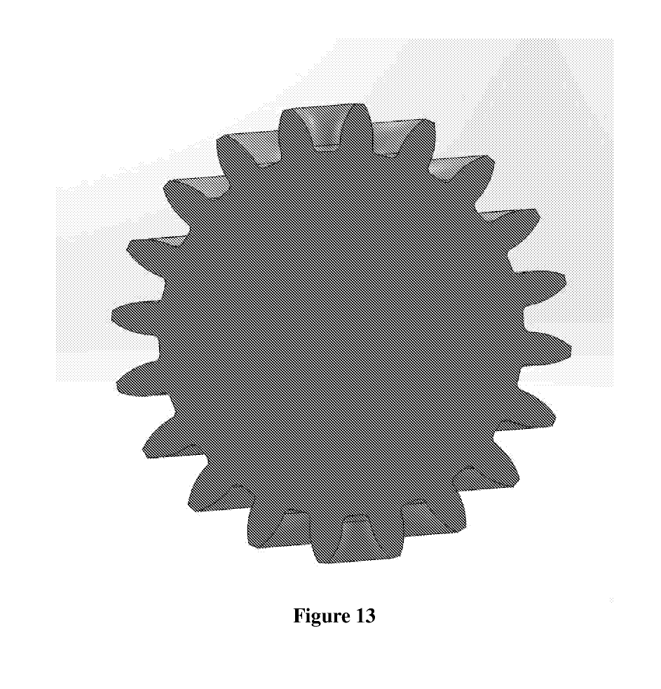

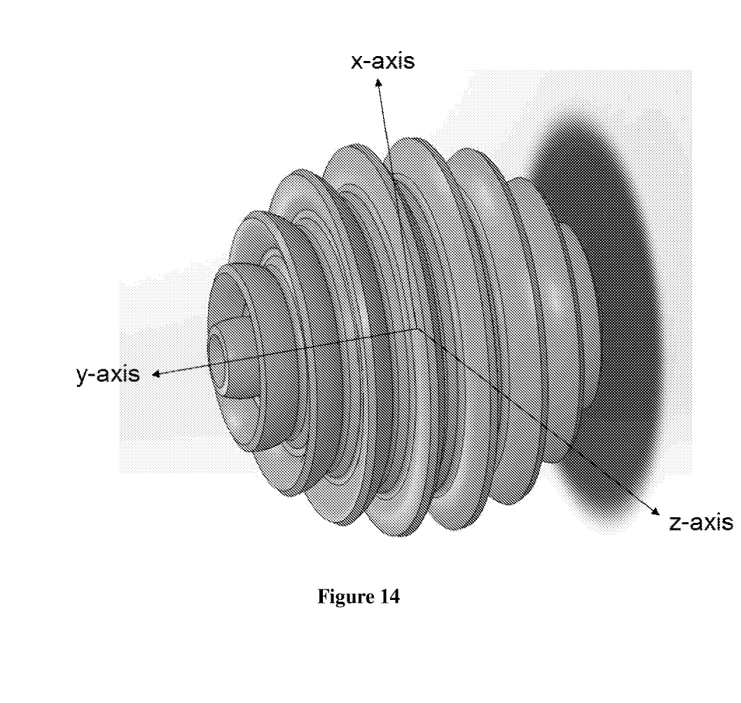

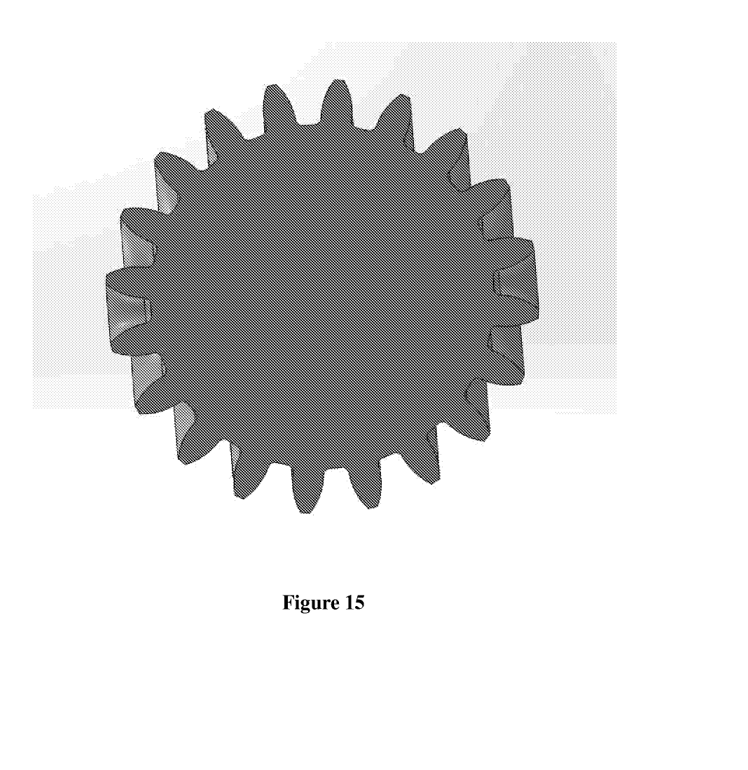

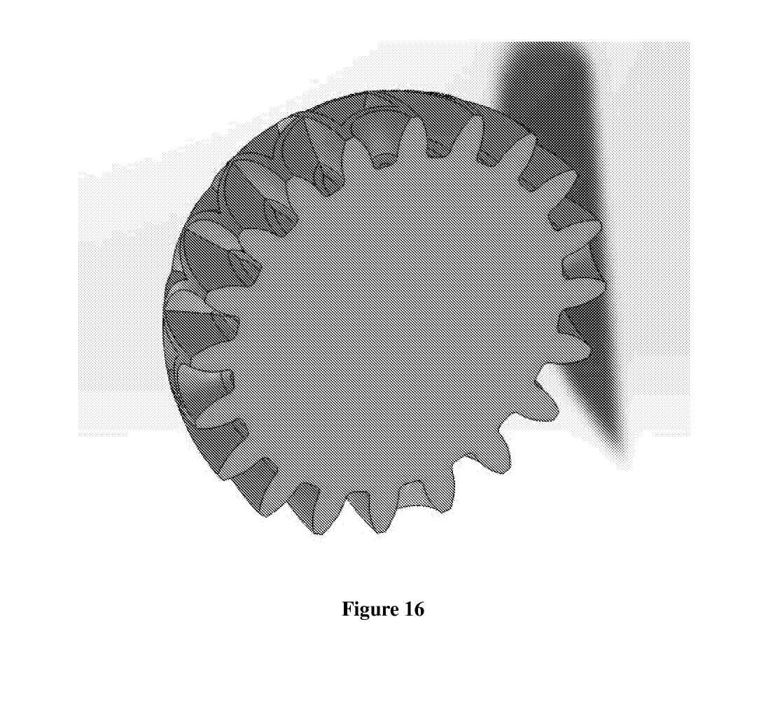

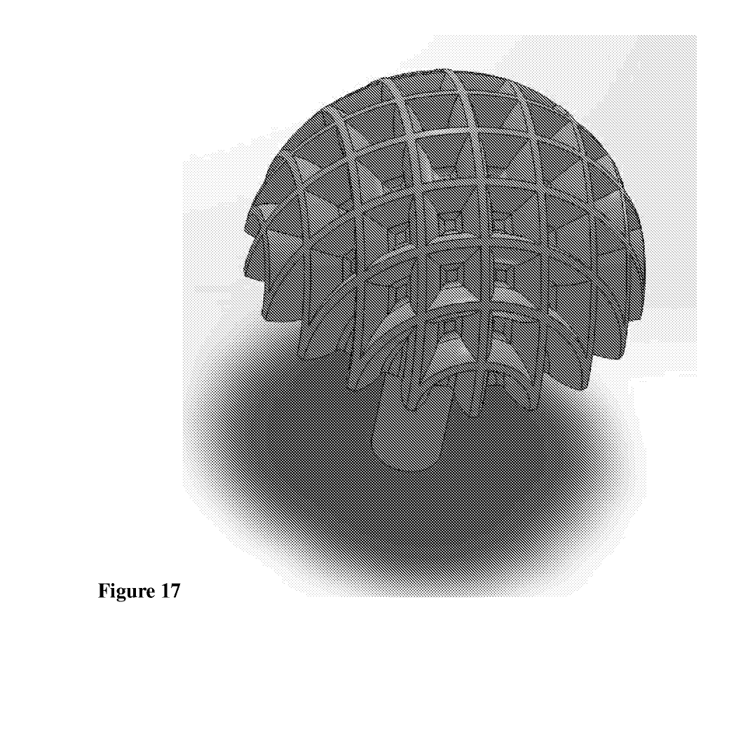

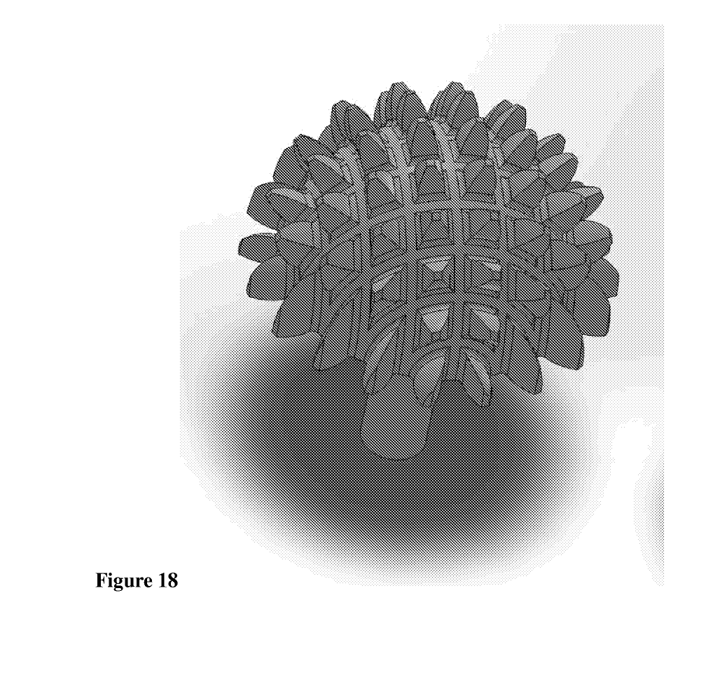

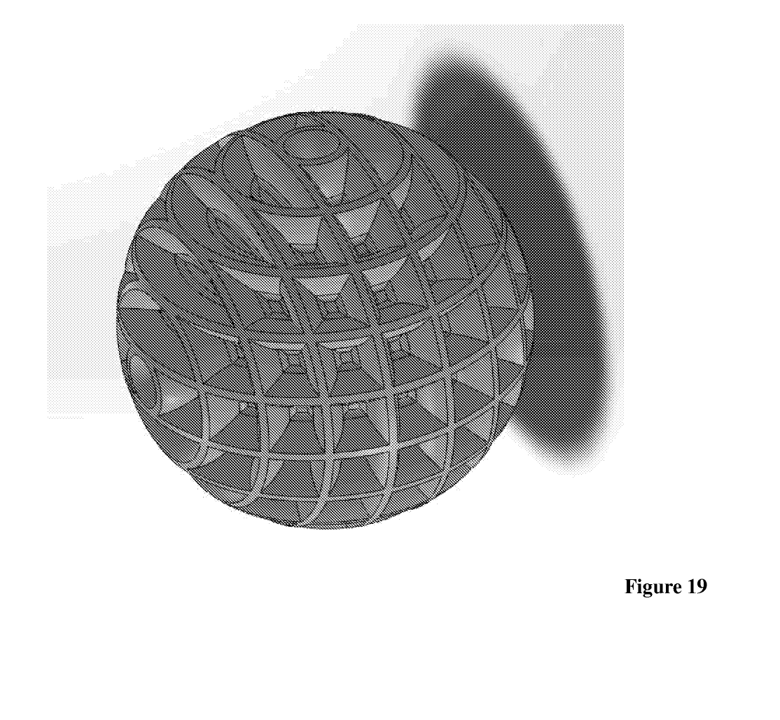

As for female spherical gear, its teeth profile is formed through OR operation of Boolean algorithm of the two involute profiles spinning around x-axis and y-axis. As for male spherical gear, its teeth profile is formed through AND operation of Boolean algorithm of the two involute profiles spinning around x-axis and y-axis. Moreover, these algorithms are compatible to both external and internal involute non-ring continuous teeth spherical gears. To better explain the AND and OR operations of Boolean algorithm, here is an example of female gear. In FIG. 12, the 2-DOF spherical gear is formed by rotating along x-axis. And its x-y plane sectional view is a common 1-DOF gear, shown in FIG. 13. Similarly, in FIG. 14, the 2-DOF spherical gear is formed by rotating along y-axis. And its x-y plane sectional view is a common 1-DOF gear, shown in FIG. 15. When these two 2-DOF spherical gears are combined together, with the OR operation of Boolean algorithm, it comes out with the 3-DOF female spherical gear, shown in FIG. 16. Then cut the whole spherical gear into part so that, a cylindrical pin or similar chucking mechanism can be assembled, shown in FIGS. 17 and 18. Similarly, the AND operation of Boolean algorithm forms the male spherical gear, shown in FIG. 19. The algorithms satisfy that each concave tooth on female gear matches one convex tooth on male gear. For the convenience of fabrication and assembly, part of female and male spherical gears is cylindrical pin or similar chucking mechanism.

During the assembly of spherical gears, the center concave tooth of female gear and the center convex tooth of male gear must pair each other.

Both female and male spherical gears can rotate around itself x, y and z axes. After paired, one becomes driving gear while the other becomes driven. Rotation around driving gear's x, y and z axes can simultaneously pass to the driven so that driven gear can rotate around itself x, y and z axes.

Linked through such a spherical gear mechanism, female gear and male gear can completely engage and continuously rotate. And its design regularity is the same as that of common one degree-of-freedom gear, which is involute tooth profile for continuous engagement, therefore such spherical gears have the same transmission features as common one degree-of-freedom gear, like fixed transmission ratio and efficiency.

This design for an involute, non-ring, continuous teeth, spherical gear transmission mechanism solves problems that distributed-teeth spherical gear cannot provide, namely, an accurate fixed ratio transmission, and that spherical involute gear can only provide two degrees of freedom. It provides a better condition of spherical gear mechanism for wide use in practical engineering applications.

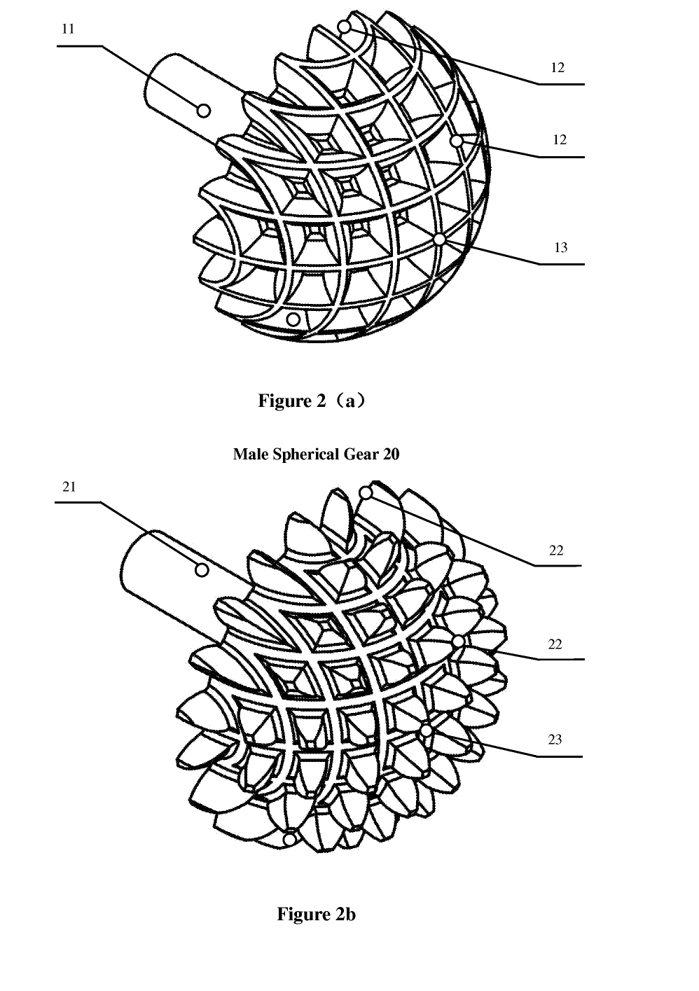

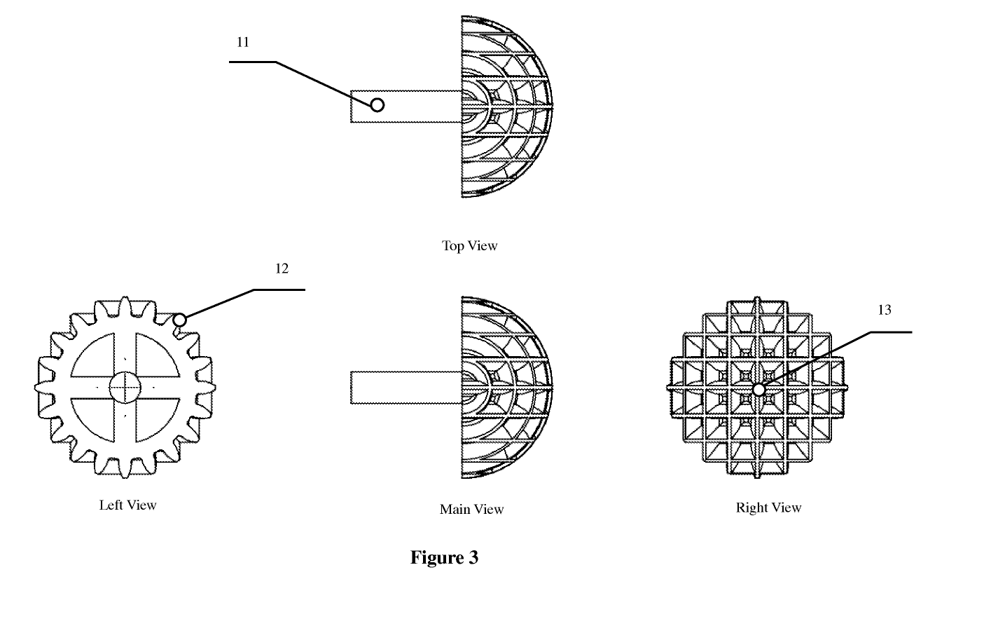

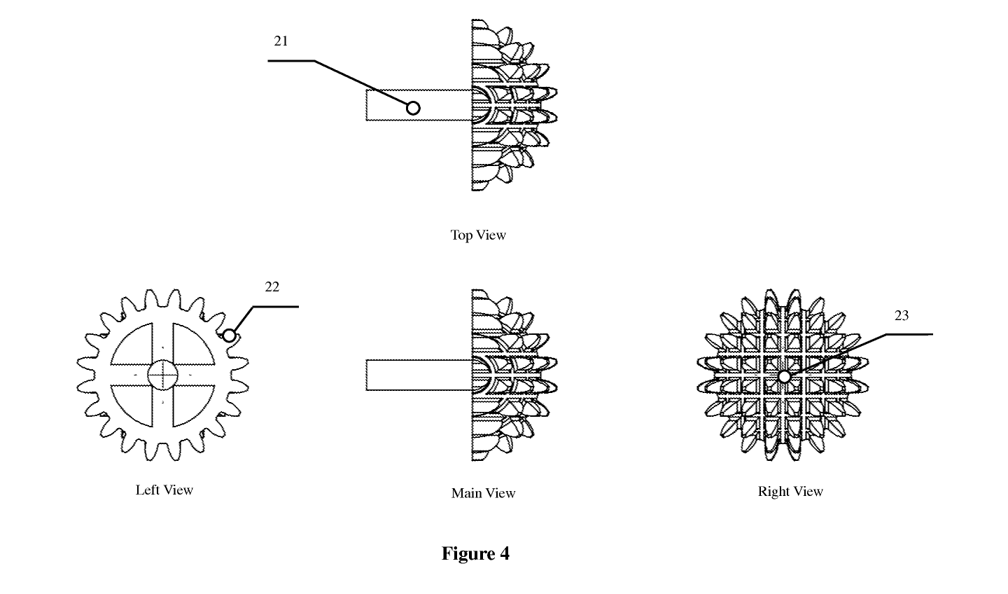

A pair of involute non-ring continuous teeth spherical gears is composed of one female spherical gear 10, shown in FIG. 2(a), and one male spherical gear 20, shown in FIG. 2(b). The involute teeth profile 12 and 22 of both female spherical gear 10 and one male spherical gear 20 has the same design regulation as a common one degree-of-freedom gear, which means the algorithm is calculated on gear modulus m and tooth numbers z. The calculated results include pitch sphere diameter, root sphere diameter, outside sphere diameter and other design parameters. Therefore such spherical gears have the same transmission features as common one degree-of-freedom gear, like fixed transmission ratio and efficiency. Two sets of tooth profiles around x and y axis are generated based on such design parameters. As for female spherical gear 10, its teeth profile is formed through OR operation of Boolean algorithm of the two involute profiles spinning around x-axis and y-axis. As for male spherical gear 20, its teeth profile is formed through AND operation of Boolean algorithm of the two involute profiles spinning around x-axis and y-axis. The algorithms satisfy that each concave tooth on female gear 10 matches one convex tooth on male gear 20. For better explanation, a pair of spherical gears with specifications of 1:1 transmission ratio, 1.5 gear modulus and 20 teeth is used below.

In practical engineering applications, teeth are not usually covered the entire gear surface. For the convenience of fabrication and assembly, part of ale and male spherical gears is cylindrical pin or similar chucking mechanism. In the sample figures, half surface of female spherical gear 10 and male spherical gear 20 is covered with gear teeth and on the other half there are chucking pins 11 and 21, shown in FIG. 2(a) and FIG. 2(b).

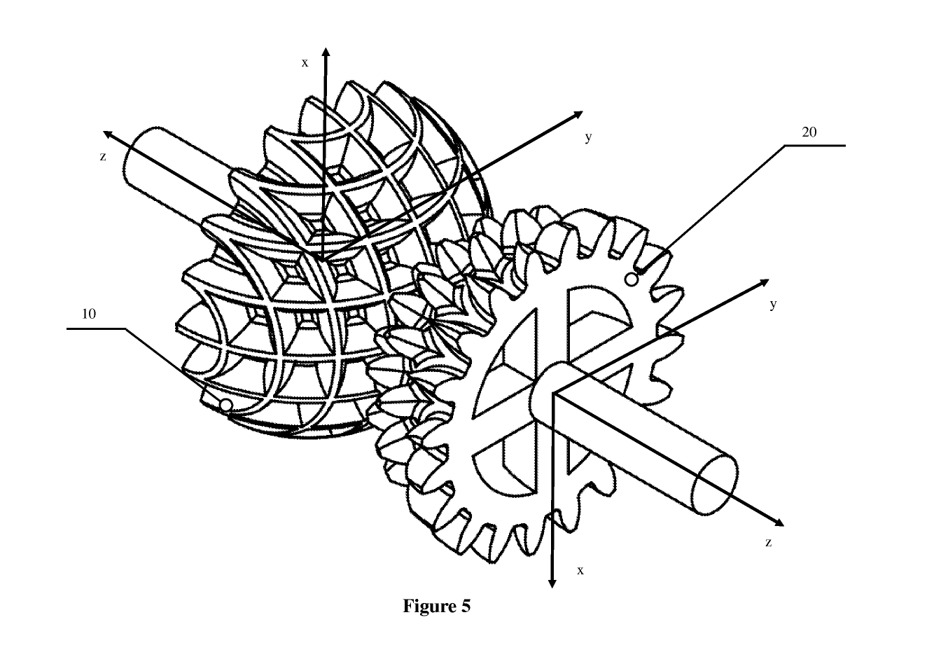

During the assembly of spherical gears, the center concave tooth of female gear 13 and the center convex tooth of male gear 23 must pair each other, shown in FIG. 5. After being paired, one becomes driving gear while the other becomes driven. For better explanation, in this instruction female gear is regarded as the driving while male gear is the driven.

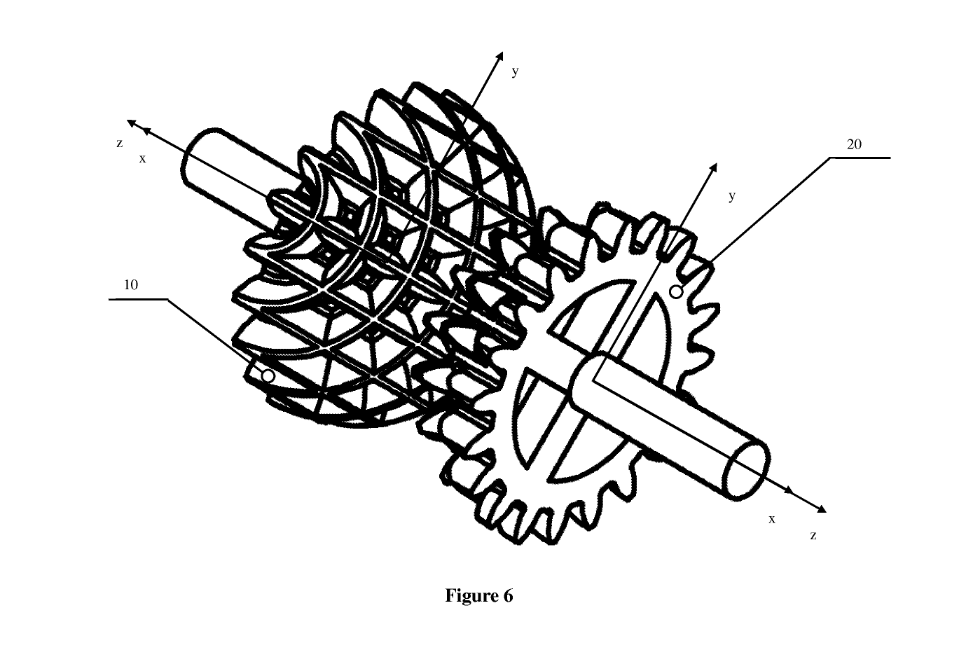

When female gear 10 (driving gear) rotates around itself z-axis, male gear 20 (driven gear) is forced to rotate around itself z-axis. If FIG. 5 is the initiation status, after female gear 10 (driving gear) rotates 45 degrees CCW (counter clock-wise) around itself z-axis, an engagement is shown in FIG. 6.

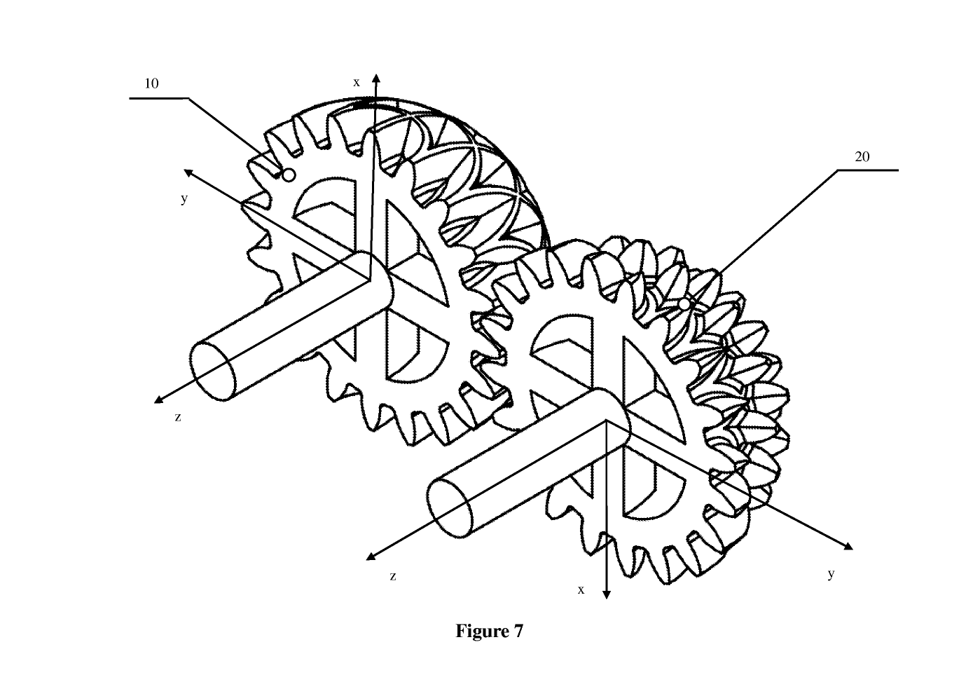

When female gear 10 (driving gear) rotates around itself x-axis, male gear 20 (driven gear) is forced to rotate around itself x-axis. If FIG. 5 is the initiation status, after female gear 10 (driving gear) rotates 90 degrees around itself x-axis, an engagement is shown in FIG. 7.

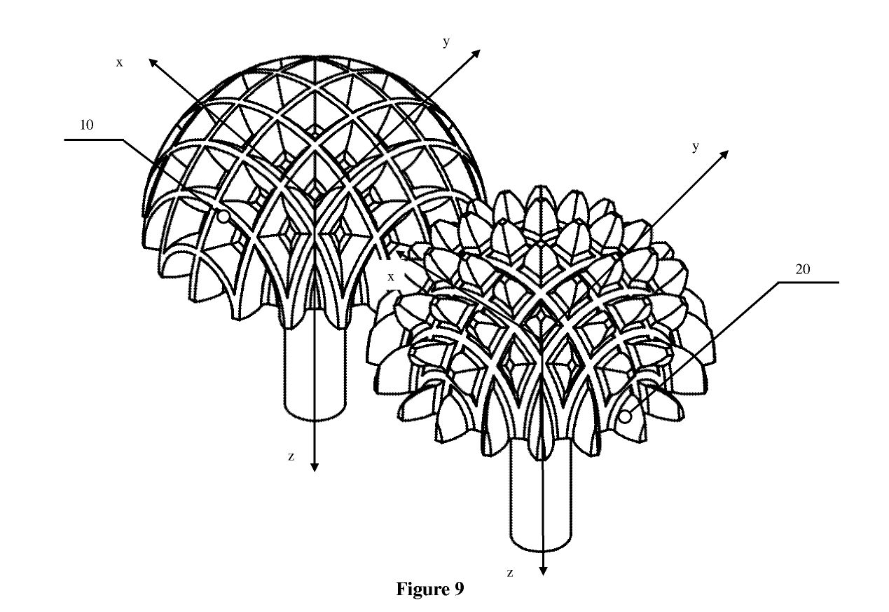

When female gear 10 (driving gear) rotates around itself y-axis, male gear 20 (driven gear) is forced to rotate around itself y-axis. If FIG. 5 is the initiation status, after female gear 10 (driving gear) rotates 90 degrees around itself y-axis, an engagement is shown in FIG. 9.

The three previous paragraphs describe such spherical gears motion, including three degree-of-freedoms. No matter female gear 10 (driving gear) rotates around its x, y or z axis, male gear 20 (driven) gear rotates relatively. Therefore, it keeps engaged in any rotation status, which realize the three degree-of-freedoms motion of spherical gear. Moreover, three rotations of driving gear is mutually independent, thus this spherical gear mechanism can pass all three rotations to driven gear. In this way, the below facts are proved.

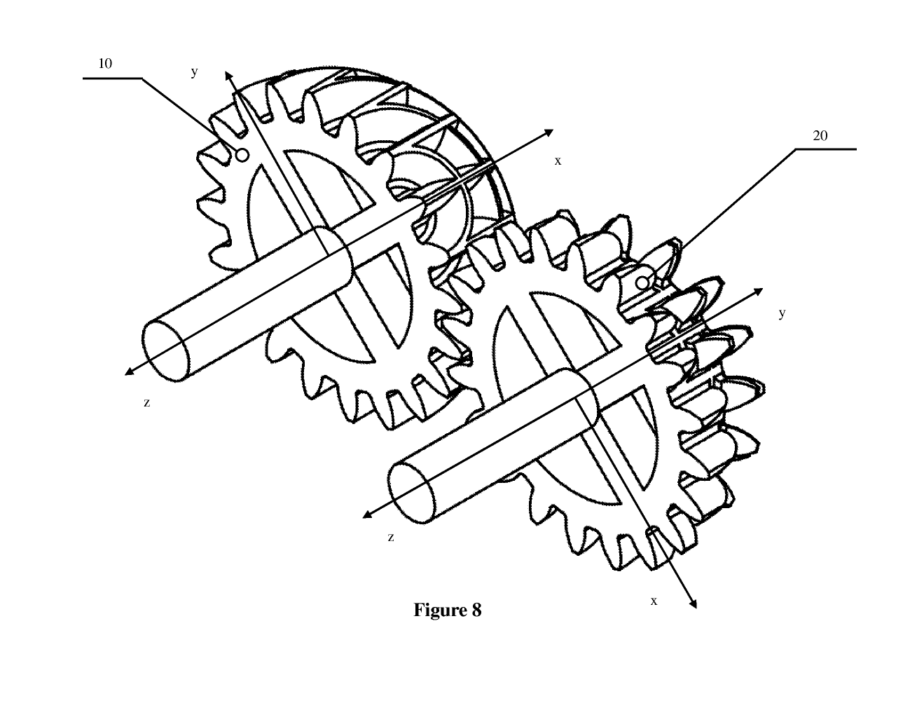

If FIG. 7 is the initiation status, after female gear 10 (driving gear) rotates 45 degrees around itself z-axis, an engagement is shown in FIG. 8.

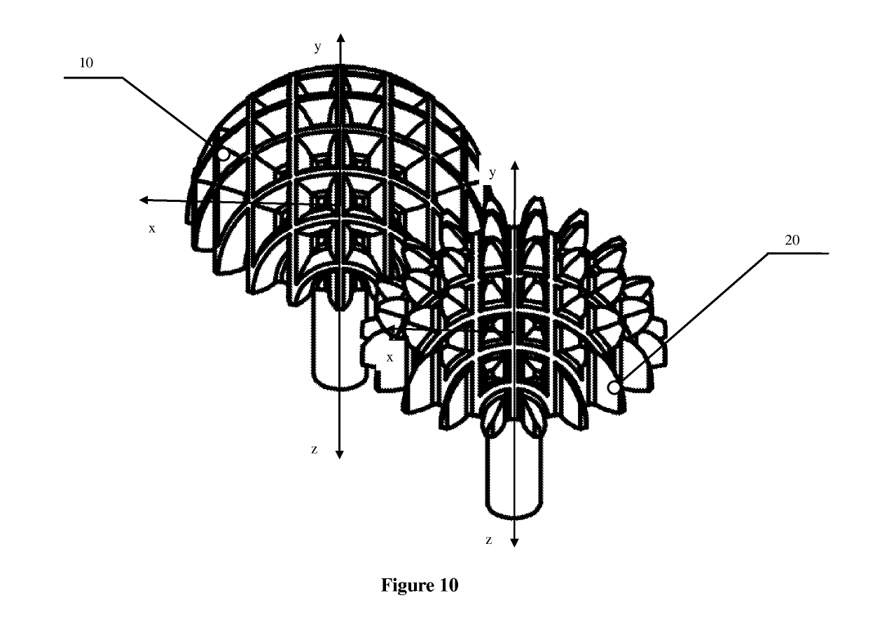

If FIG. 9 is the initiation status, after female gear 10 (driving gear) rotates 45 degrees around itself z-axis, an engagement is shown in FIG. 10.

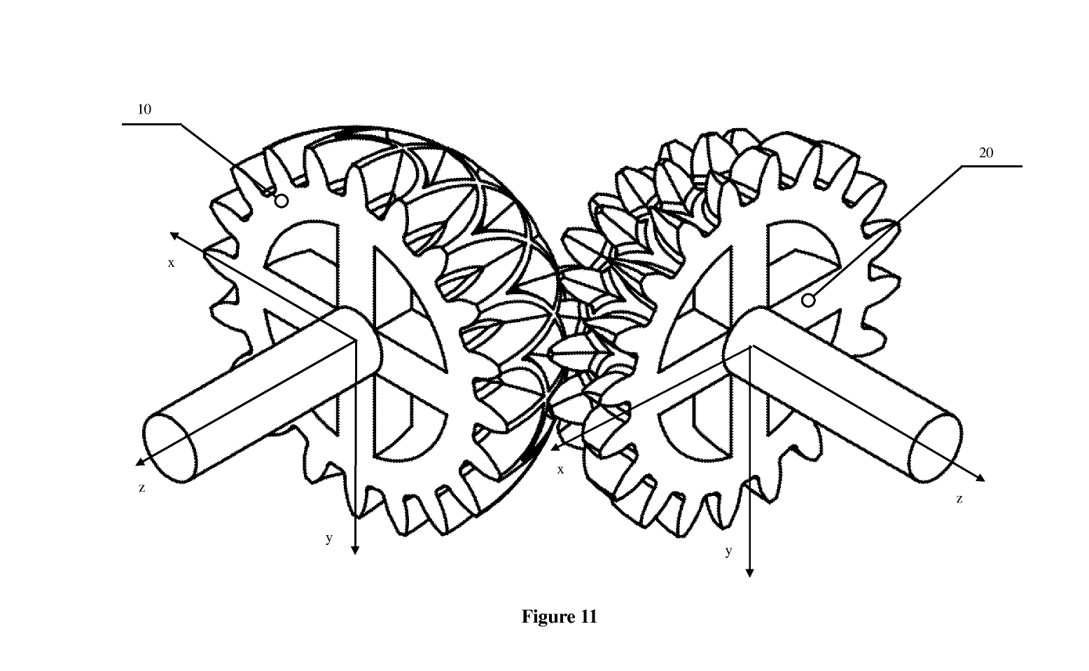

If FIG. 10 is the initiation status, after female gear 10 (driving gear) rotates 90 degrees around itself x-axis, an engagement is shown in FIG. 11.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. An involute non-ring continuous teeth spherical gear transmission mechanism, comprising:
a female spherical gear (1) and a male spherical gear (2) to form a three degree-of-freedom deputy campaign, the teeth profiles of female gear (1) and male gear (2) are based on the same design regularity as that of common one degree-of-freedom gear, where the calculated results include addendum sphere diameter, root sphere diameter, base sphere diameter and other design parameters.

2. The involute non-ring continuous teeth spherical gear transmission mechanism of claim 1, wherein the a teeth profile of the female spherical gear is formed through OR algorithm of the two involute profiles spinning around x-axis and y-axis, and the teeth profile for the male spherical gear is formed through AND algorithm of the two involute profiles spinning around x-axis and y-axis, and the algorithms are compatible to both external and internal involute non-ring continuous teeth spherical gears.

3. The involute non-ring continuous teeth spherical gear transmission mechanism of claim 1 of claim 2, wherein the algorithms satisfy that each concave tooth on female gear (1) matches one convex tooth on male gear (2).

4. The involute non-ring continuous teeth spherical gear transmission mechanism of claim 1, wherein part of the female spherical gear (1) and part of the male spherical gear (2) is a cylindrical pin (3) or similar chucking mechanism.

5. The involute non-ring continuous teeth spherical gear transmission mechanism of claim 1, wherein during the assembly of spherical gears, the center concave tooth of female gear (5) and the center convex tooth of male gear (6) must pair each other.

6. The involute non-ring continuous teeth spherical gear transmission mechanism of claim 1, wherein both female spherical gear (1) and male spherical gear (2) can rotate around itself x, y and z axises, and after being paired, one becomes driving gear while the other becomes driven, and rotation around driving gear's x, y and z axises can simultaneously pass to the driven so that driven gear can rotate around itself x, y and z axises.
